(19) United States
(12) Patent Application Publication
(10) Pub. No.: US 2024/0098656 A1
(43) Pub. Date: Mar. 21, 2024

(54) PANEL-SPECIFIC MAXIMUM PERMITTED EXPOSURE INDICATIONS

(71) Applicant: QUALCOMM Incorporated, San Diego, CA (US)

(72) Inventors: Ruiming ZHENG, Beijing (CN); Linhai HE, San Diego, CA (US)

(21) Appl. No.: 18/255,329

(22) PCT Filed: Jan. 13, 2021
(86) PCT No.: PCT/CN21/71440

§ 371 Date: May 31, 2023

(51) Int. Cl. H04W 52/36; H04W 52/42

(52) U.S. Cl. CPC H04W 52/367; H04W 52/42

(57) ABSTRACT

Various aspects of the present disclosure generally relate to wireless communication. In some aspects, a user equipment (UE) may receive a panel-specific maximum permitted exposure (MPE) reporting configuration. The UE may transmit a panel-specific MPE report based at least in part on the panel-specific MPE reporting configuration. Numerous other aspects are described.

### FIELD OF THE DISCLOSURE

Aspects of the present disclosure generally relate to wireless communication and to techniques and apparatuses for panel-specific maximum permitted exposure indications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes a memory; and one or more processors operatively coupled to the memory, the memory and the one or more processors configured to: receive a panel-specific maximum permitted exposure (MPE) reporting configuration; and transmit a panel-specific MPE report based at least in part on the panel-specific MPE reporting configuration.

In some aspects, a base station for wireless communication includes a memory; and one or more processors operatively coupled to the memory, the memory and the one or more processors configured to: transmit a panel-specific MPE reporting configuration; and receive a panel-specific MPE report based at least in part on the panel-specific MPE reporting configuration.

In some aspects, a method of wireless communication performed by a UE includes receiving a panel-specific MPE reporting configuration; and transmitting a panel-specific MPE report based at least in part on the panel-specific MPE reporting configuration.

In some aspects, a method of wireless communication performed by a base station includes transmitting a panel-specific MPE reporting configuration; and receiving a panel-specific MPE report based at least in part on the panel-specific MPE reporting configuration.

In some aspects, a non-transitory computer-readable medium storing a set of instructions for wireless communication includes one or more instructions that, when executed by one or more processors of a UE, cause the UE to: receive a panel-specific MPE reporting configuration; and transmit a panel-specific MPE report based at least in part on the panel-specific MPE reporting configuration.

In some aspects, a non-transitory computer-readable medium storing a set of instructions for wireless communication includes one or more instructions that, when executed by one or more processors of a base station, cause the base station to: transmit a panel-specific MPE reporting configuration; and receive a panel-specific MPE report based at least in part on the panel-specific MPE reporting configuration.

In some aspects, an apparatus for wireless communication includes means for receiving a panel-specific MPE reporting configuration; and means for transmitting a panel-specific MPE report based at least in part on the panel-specific MPE reporting configuration.

In some aspects, an apparatus for wireless communication includes means for transmitting a panel-specific MPE reporting configuration; and means for receiving a panel-specific MPE report based at least in part on the panel-specific MPE reporting configuration.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a user equipment (UE) in a wireless network, in accordance with various aspects of the present disclosure.

FIGS. 3-11 are diagrams illustrating examples associated with panel-specific maximum permitted exposure (MPE) indications, in accordance with various aspects of the present disclosure.

FIGS. 12 and 13 are diagrams illustrating example processes associated with panel-specific MPE indications, in accordance with various aspects of the present disclosure.

FIGS. 14 and 15 are block diagrams of example apparatuses for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

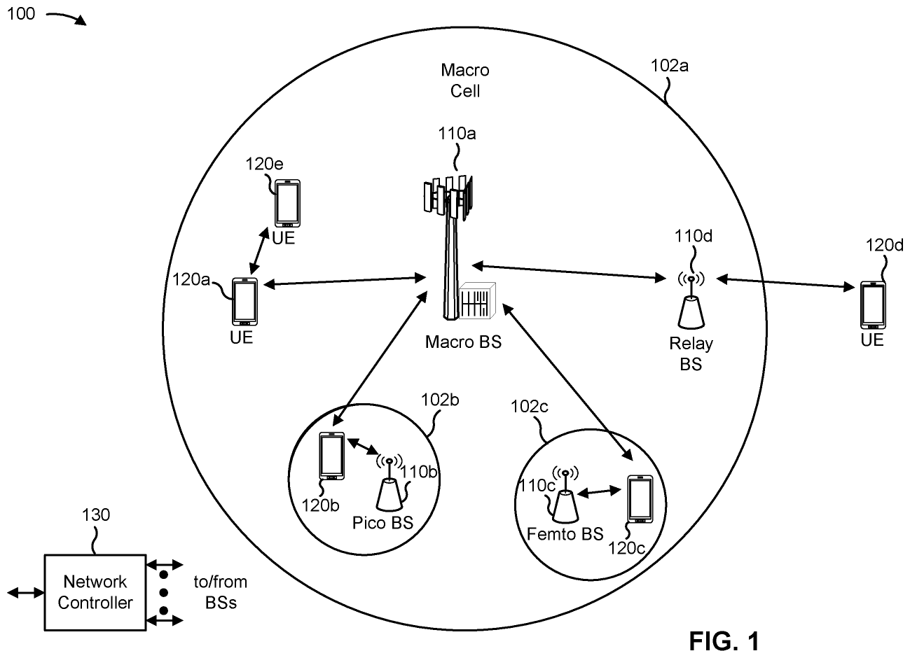

FIG. 1 is a diagram illustrating an example of a wireless network 100, in accordance with various aspects of the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

In some aspects, the wireless network 100 may include one or more non-terrestrial network (NTN) deployments in which a non-terrestrial wireless communication device may include a UE (referred to herein, interchangeably, as a “non-terrestrial UE”), a BS (referred to herein, interchangeably, as a “non-terrestrial BS” and “non-terrestrial base station”), a relay station (referred to herein, interchangeably, as a “non-terrestrial relay station”), and/or the like. As used herein, an NTN may refer to a network for which access is facilitated by a non-terrestrial UE, non-terrestrial BS, a non-terrestrial relay station, and/or the like.

The wireless network 100 may include any number of non-terrestrial wireless communication devices. A non-terrestrial wireless communication device may include a satellite, a manned aircraft system, an unmanned aircraft system (UAS) platform, and/or the like. A satellite may include a low-earth orbit (LEO) satellite, a medium-earth orbit (MEO) satellite, a geostationary earth orbit (GEO) satellite, a high elliptical orbit (HEO) satellite, and/or the like. A manned aircraft system may include an airplane, helicopter, a dirigible, and/or the like. A UAS platform may include a high-altitude platform station (HAPS), and may include a balloon, a dirigible, an airplane, and/or the like. A non-terrestrial wireless communication device may be part of an NTN that is separate from the wireless network 100. Alternatively, an NTN may be part of the wireless network 100. Satellites may communicate directly and/or indirectly with other entities in wireless network 100 using satellite communication. The other entities may include UEs (e.g., terrestrial UEs and/or non-terrestrial UEs), other satellites in the one or more NTN deployments, other types of BSs (e.g., stationary and/or ground-based BSs), relay stations, one or more components and/or devices included in a core network of wireless network 100, and/or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

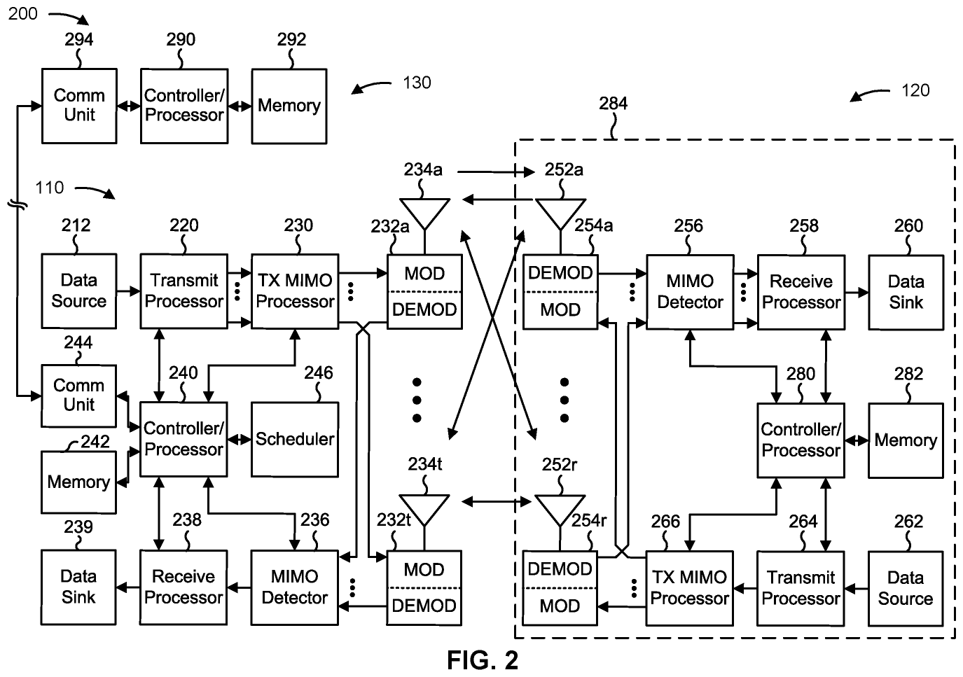

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

Each of the antenna elements may include one or more sub-elements for radiating or receiving radio frequency (RF) signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more or all of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

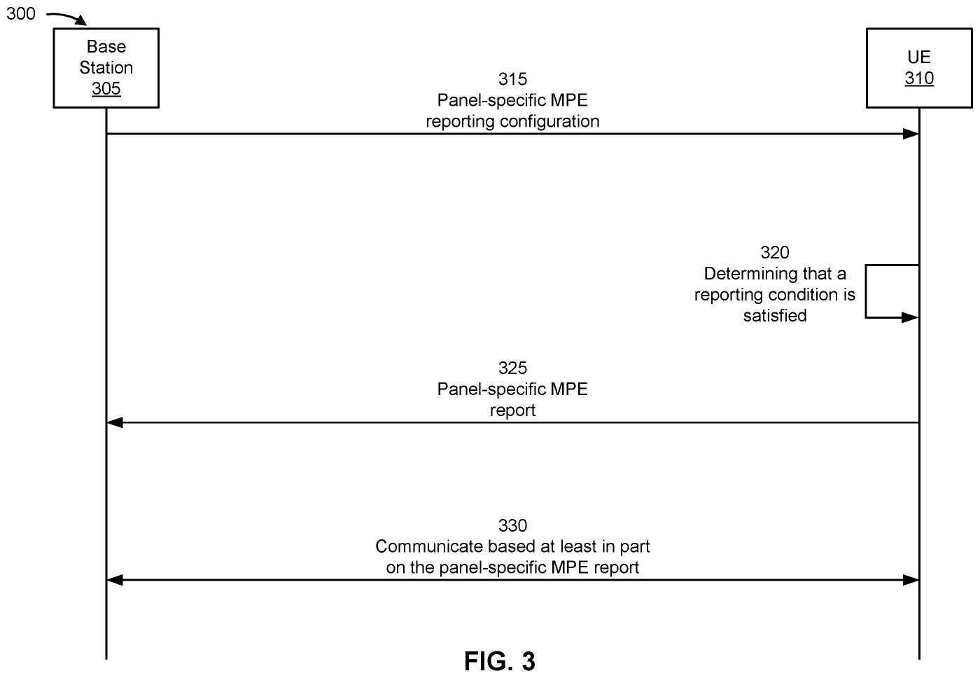

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM) and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 3-13.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 3-13.

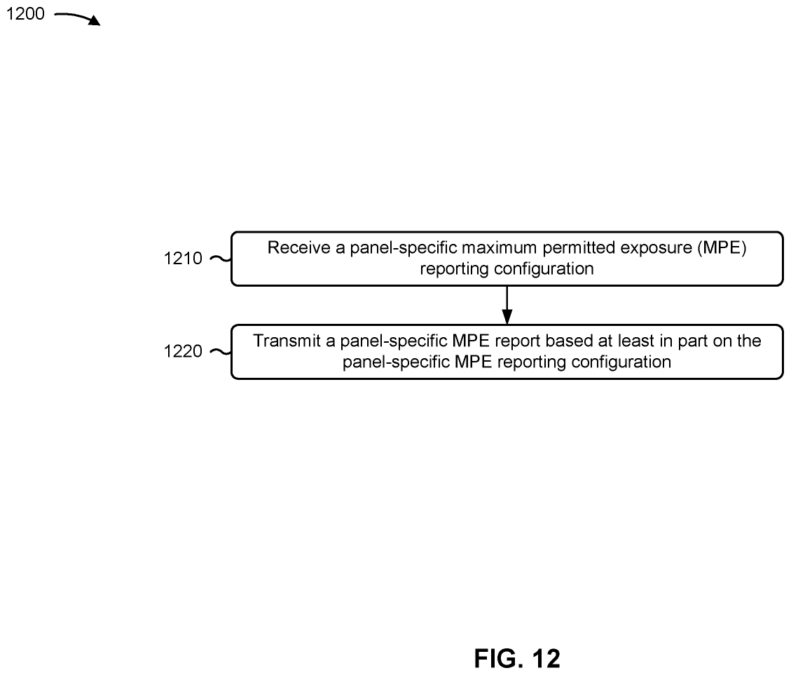

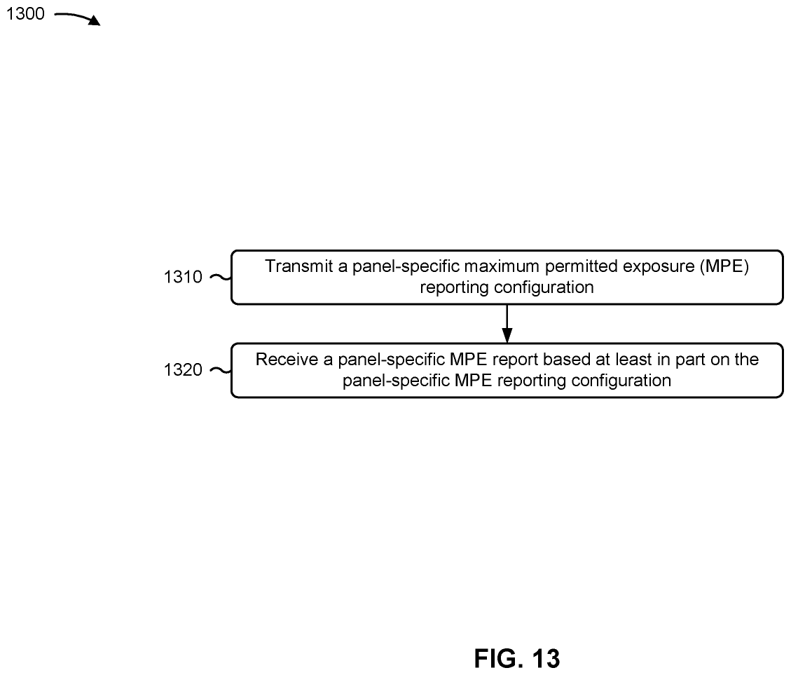

Controller/processor 240 of base station 110, controller/processor 280 of UE 120, and/or any other component(s) of FIG. 2 may perform one or more techniques associated with panel-specific maximum permitted exposure (MPE) indications, as described in more detail elsewhere herein. For example, controller/processor 240 of base station 110, controller/processor 280 of UE 120, and/or any other component(s) of FIG. 2 may perform or direct operations of, for example, process 1200 of FIG. 12, process 1300 of FIG. 13, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1200 of FIG. 12, process 1300 of FIG. 13, and/or other processes as described herein. In some aspects, executing instructions may include running the instructions, converting the instructions, compiling the instructions, and/or interpreting the instructions, among other examples.

In some aspects, the UE includes means for receiving a panel-specific MPE reporting configuration; or means for transmitting a panel-specific MPE report based at least in part on the panel-specific MPE reporting configuration. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

In some aspects, the UE includes means for determining that at least one panel associated with a serving cell in a medium access control (MAC) entity, of a plurality of panels associated with a plurality of serving cells, has a corresponding power management maximum power reduction (P-MPR) that satisfies a P-MPR threshold,

In some aspects, the UE includes means for determining that a cumulative P-MPR associated with a serving cell of a plurality of serving cells satisfies a P-MPR threshold. In some aspects, the UE includes means for determining that a relative P-MPR associated with at least one panel of a plurality of panels satisfies a power change threshold.

In some aspects, the UE includes means for determining that a prohibition timer associated with the relative P-MPR is not running. In some aspects, the UE includes means for starting the prohibition timer associated with the relative P-MPR based at least in part on transmitting the panel-specific MPE report.

In some aspects, the UE includes means for determining that at least one panel of a plurality of panels associated with a serving cell satisfies a reporting condition; and/or means for setting a power backoff indication field of the medium access control control element (MAC CE) equal to one based at least in part on determining that the at least one panel satisfies the reporting condition. In some aspects, the UE includes means for determining that at least one additional panel of the plurality of panels associated with the serving cell fails to satisfy the reporting condition.

In some aspects, the base station includes means for transmitting a panel-specific MPE reporting configuration; and/or means for receiving a panel-specific MPE report based at least in part on the panel-specific MPE reporting configuration. The means for the base station to perform operations described herein may include, for example, one or more of transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

Because UEs may emit RF waves, microwaves, and/or other radiation, UEs are generally subject to regulatory RF safety requirements that set forth specific guidelines, or MPE limits, that constrain various operations that the UEs can perform. For example, RF emissions may generally increase when a UE is transmitting, and the RF emissions may further increase in cases where the UE is performing frequent transmissions, high-power transmissions, and/or the like. Accordingly, because frequent and/or high-power transmission may lead to significant RF emissions, regulatory agencies (e.g., the Federal Communications Commission (FCC) in the United States) may provide information related to acceptable RF radiation exposure when UEs are communicating using different radio access technologies.

For example, when a UE is communicating using radio access technologies that operate in a frequency range below 6 GHz, the applicable RF exposure parameter is a specific absorption rate (SAR), which refers to a rate at which the human body absorbs energy when exposed to RF energy (e.g., power absorbed per unit of mass, which may be expressed according to watts per kilogram (W/kg)). In particular, SAR requirements generally specify that overall radiated power by a UE is to remain under a certain level to limit heating that may occur when RF energy is absorbed. In another example, when a UE is communicating using a radio access technology that operates in a high frequency range, such as a millimeter wave (mmW) frequency range, the applicable RF exposure parameter is power density, which may be regulated to limit heating of the UE and/or nearby surfaces.

Accordingly, UEs generally have to satisfy MPE limits, which are typically regulatory requirements that are defined in terms of aggregate exposure over a certain amount of time, and the aggregate exposure may be averaged over a moving integration window (or moving time window). In some cases, a UE may satisfy the MPE limits by applying a power management maximum power reduction (P-MPR) to reduce the transmission power. The P-MPR may refer to a maximum allowed UE output power reduction for a serving cell.

The UE may report the P-MPR to a base station to facilitate efficient communication. The P-MPR may be reported as part of a power headroom (PHR) report, which may be reported using a PHR MAC CE. For example, a PHR MAC CE may be enhanced to report P-MPR information. In some cases, a two-bit MPE field may be provided by reusing reserve bits to indicate the applied power backoff to meet an MPE requirement.

P-MPR reporting may be event triggered based on the P-MPR exceeding a network configured threshold (e.g., an absolute P-MPR value, which may be specified using a parameter mpe-Threshold). In some cases, P-MPR reporting may be triggered if at least one serving cell handled by a MAC entity of the UE has a corresponding P-MPR that exceeds the threshold. The same threshold value may apply to each serving cell.

The PHR report also may report a PHR value, which may correspond to a difference between an actual transmit power at which the UE is operating and the maximum configured power. PHR reporting may be triggered when power backoff due to P-MPR for a cell has changed more than a threshold since the last transmission of a PHR. That threshold may be specified as a parameter phr-Tx-PowerFactorChange.

To mitigate overreporting of P-MPR, P-MPR reporting may have an associated prohibit timer, specified as a variable mpe-ProhibitTimer. A separate value is configured for each MAC entity of the UE (e.g., for each serving cell). The prohibit timer may be started, or restarted if it has been stopped, based on a PHR report including a report of a P-MPR.

The MPE reporting described above may suffer from inefficiencies in the context of UEs equipped with multiple antenna panels and configured to communicate using MIMO techniques. In such cases, a UE may include multiple antenna panels, each having a set of antenna ports that facilitate generating one or more beams. By reporting MPE information (e.g., P-MPR, PHR) per serving cell, differences in MPE information that may exist for one beam, port, and/or panel may be overlooked. As a result, MPE information overreporting and/or underreporting may occur, thereby decreasing network efficiencies and/or network performance.

Some aspects described herein relate to techniques and apparatuses to provide, to a base station, a report that includes panel-specific MPE information. Panel-specific MPE information may include beam-specific MPE information, port-specific information, and/or panel-specific MPE information, since MPE information associated with a panel may be based at least in part on beam-specific MPE information and/or port-specific MPE information. Accordingly, the base station may use the panel-specific MPE to dynamically adapt scheduling for the UE to help the UE maintain the uplink connection, satisfy MPE limits, and/or the like. For example, in some aspects, the base station may, with respect to specific panels, beams, and/or ports, schedule the UE to transmit less often, modify uplink grants to reduce uplink transmit power (e.g., by scheduling a narrower uplink bandwidth or a lower modulation order), and/or the like if the report indicates that the UE has a low energy budget. In another example, the base station may schedule the UE to transmit more often, modify uplink grants to increase uplink transmit power (e.g., by scheduling a wider uplink bandwidth or a higher modulation order), and/or the like to increase performance if the report indicates that the UE has a low energy budget. In this way, by providing a panel-specific UE report to the base station that indicates the panel-specific uplink energy budget available to the UE, the base station may schedule the UE more efficiently, which improves performances, conserves network resources that may otherwise be wasted reestablishing a connection that was dropped because the UE reduced the uplink transmit power more than necessary, and/or the like. As a result, some aspects may provide increased network efficiency and/or overall performance.

FIG. 3 is a diagram illustrating an example 300 associated with panel-specific MPE indications, in accordance with various aspects of the present disclosure. As shown in FIG. 3, a base station 305 and a UE 310 may communicate with one another. The base station 305 may be, or be similar to, the base station 110, described in connection with FIGS. 1 and 2. The UE 310 may be, or be similar to, the UE 120 described in connection with FIGS. 1 and 2.

As shown by reference number 315, the base station 305 may transmit, and the UE 310 may receive, a panel-specific MPE reporting configuration. In some aspects, the panel-specific MPE reporting configuration may be transmitted using a radio resource control (RRC) message. The panel-specific MPE reporting configuration may indicate a first set of parameters corresponding to a first panel and a second set of parameters corresponding to a second panel. The panel-specific MPE reporting configuration may indicate one or more aspects associated with reporting panel-specific MPE information. For example, the panel-specific MPE reporting configuration may indicate resources to be used for reporting MPE information, one or more parameters to be reported, formats associated with reporting MPE information, trigger conditions for reporting MPE information, and/or a prohibition timer to facilitate avoiding reporting MPE information too often, among other examples.

As shown by reference number 320, the UE 310 may determine that a reporting condition is satisfied. As shown by reference number 325, based at least in part on determining that the reporting condition is satisfied, the UE 310 may transmit, and the base station 305 may receive, a panel-specific MPE report. For example, the UE 310 may transmit the panel-specific MPE report based at least in part on the panel-specific MPE reporting configuration. The panel-specific MPE report may include a MAC CE. In some aspects, the MAC CE may include a panel-specific MAC CE.

For example, in some aspects, the UE 310 may determine that at least one panel associated with a serving cell in a MAC entity, of a plurality of panels associated with a plurality of serving cells, has a corresponding P-MPR that satisfies a P-MPR threshold. Based at least in part on that determination, the panel-specific MPE report may include panel-specific MPE information associated with the at least one panel and/or at least one additional panel. In some aspects, the P-MPR threshold may be panel-specific. For example, a first P-MPR may apply to a first panel and a second P-MPR may apply to a second panel.

In some aspects, the UE 310 may determine that a cumulative P-MPR associated with a plurality of panels satisfies a P-MPR threshold, and the panel-specific MPE report may include cumulative MPE information associated with the plurality of panels. In some aspects, the UE 310 may determine whether a cumulative P-MPR associated with a serving cell of a plurality of serving cells satisfies a P-MPR threshold. In some aspects, the UE 310 may determine whether a cumulative P-MPR associated with all cells in the MAC entity satisfies a P-MPR threshold. For example, the MPE requirement may be defined per UE (e.g., not per panel or cell). In some aspects, the UE 310 may determine whether a cumulative P-MPR associated with all panels corresponding to one serving cell in the MAC entity satisfies a P-MPR threshold. For example, triggering of MPE reporting may be based on an MPE requirement corresponding to the serving cell.

In some aspects, the UE 310 may determine that a relative P-MPR satisfies a power change threshold. For example, in some aspects, the UE 310 may determine that a relative P-MPR associated with at least one panel of a plurality of panels satisfies a power change threshold. For example, the UE 310 may determine whether a difference between a current PHR value and a prior PHR value satisfies a power change threshold. The power change threshold may be specified using a variable phr-Tx-PowerFactorChange. In some aspects, the UE 310 may be triggered to transmit a panel-specific MPE report, based at least in part on the difference satisfying the power change threshold, only if the change in PHR value was caused due to applying a measured P-MPR to satisfy MPE requirements, where the P-MPR satisfies a P-MPR threshold. In some aspects, the prior PHR value may correspond to a most recent transmission of a PHR, where that transmission was triggered by the P-MPR satisfying the P-MPR threshold. In some aspects, the power change threshold may be panel-specific.

In some aspects, the UE 310 may determine that a prohibition timer associated with panel-specific MPE report (e.g., associated with MPE reporting) is not running and may transmit the panel-specific MPE report based at least in part on determining that the prohibition timer associated with the panel-specific MPE report is not running. In some aspects, the UE 310 may start the prohibition timer associated with the MPE reporting and based at least in part on transmitting the panel-specific MPE report. In some aspects, the prohibition timer may include a panel-specific prohibition timer. The prohibition timer may be started based at least in part on transmitting the panel-specific MPE report. The UE 310 may be configured to refrain from transmitting an MPE report until expiry of the prohibition timer.

As shown by reference number 330, the base station 305 and the UE 310 may communicate with one another based at least in part on the panel-specific MPE report. For example, the base station 305 may transmit a resource allocation to the UE 310 based at least in part on the panel-specific MPE report.

As indicated above, FIG. 3 is provided as an example. Other examples may differ from what is described with respect to FIG. 3.

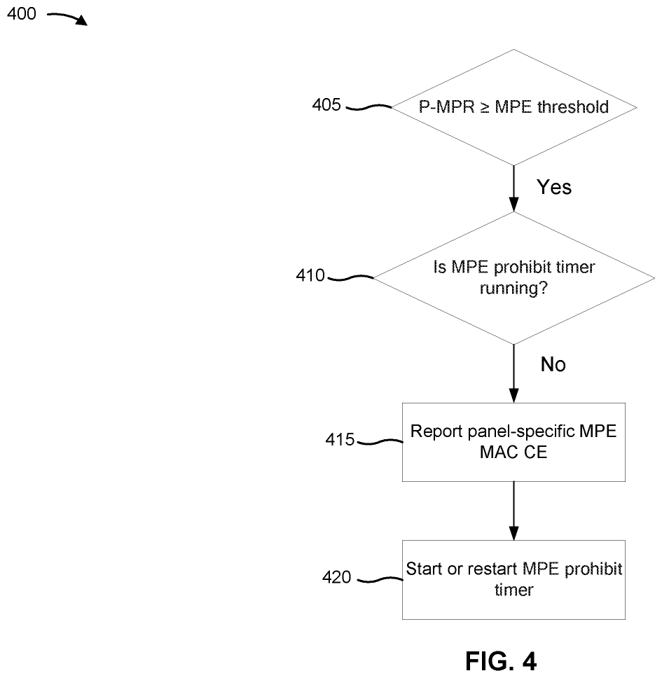

FIG. 4 is a diagram illustrating an example 400 of a procedure associated with reporting panel-specific MPE indications, in accordance with various aspects of the present disclosure. Example 400 may be performed by a UE such as, for example, the UE 310 shown in FIG. 3.

As shown by reference number 405, the UE may determine whether a P-MPR associated with at least one panel of at least one serving cell is greater than or equal to an MPE threshold. The MPE threshold may be, for example, a specified MPE value. As shown by reference number 410, if the P-MPR is greater than or equal to the MPE threshold, the UE may determine whether an MPE prohibition timer is running. If the MPE prohibition timer is not running, the UE may report a panel-specific MPE MAC CE, as shown by reference number 415. If the MPE prohibition timer is running, the UE may refrain from reporting MPE information until expiry of the timer. Based at least in part on prohibition the panel-specific MPE MAC CE, the UE may start (or restart) the MPE prohibition timer, as shown by reference number 420. The UE may refrain from transmitting another MPE MAC CE until expiry of the prohibition timer.

In some aspects, the MPE prohibition timer may be panel-specific. The UE may report MPE information associated with a first panel, based at least in part on determining that a first a MPE prohibition timer is running. The UE may refrain from reporting MPE information associated with a second panel, based at least in part on determining that a second MPE prohibition timer is expired.

As indicated above, FIG. 4 is provided as an example. Other examples may differ from what is described with respect to FIG. 4.

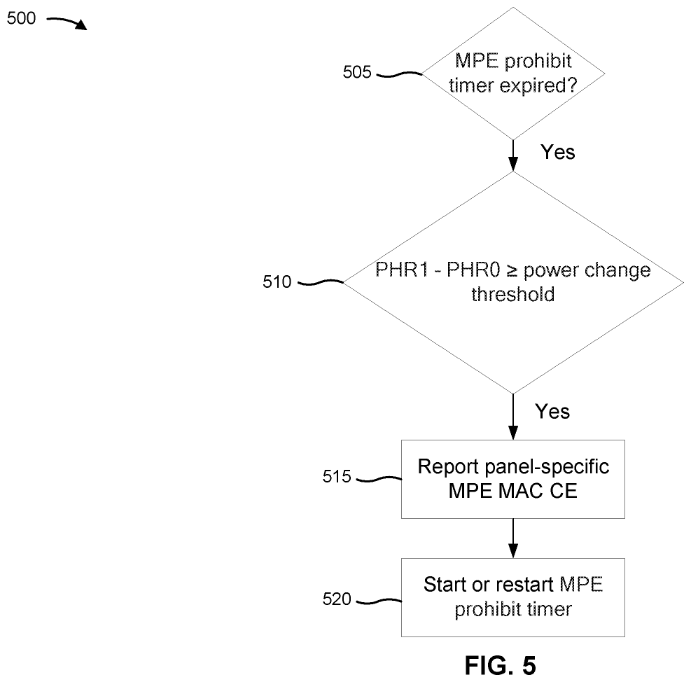

FIG. 5 is a diagram illustrating an example 500 of a procedure associated with reporting panel-specific MPE indications, in accordance with various aspects of the present disclosure. Example 500 may be performed by a UE such as, for example, the UE 310 shown in FIG. 3.

As shown by reference number 505, the UE may determine whether an MPE prohibit timer is expired. If so, the UE may determine whether a difference between a current PHR value (shown as “PHR1”) and a prior PHR value (shown as “PHR0”) satisfies a power change threshold. The power change threshold may be specified using a variable phr-Tx-PowerFactorChange. In some aspects, the UE 310 may be triggered to transmit a panel-specific MPE report, based at least in part on the difference satisfying the power change threshold, only if the change in PHR value was caused due to applying a measured P-MPR to satisfy MPE requirements, where the P-MPR satisfies a P-MPR threshold. In some aspects, the prior PHR value may correspond to a most recent transmission of a PHR, where that transmission was triggered by the P-MPR satisfying the P-MPR threshold, as shown by reference number 510. As shown by reference number 515, if the relative P-MPR threshold is greater than or equal to the relative P-MPR threshold, the UE may report a panel-specific MPE MAC CE. As shown by reference number 520, the UE may start (or restart) an MPE prohibit timer based at least in part on reporting the panel-specific MPE MAC CE.

As indicated above, FIG. 5 is provided as an example. Other examples may differ from what is described with respect to FIG. 5.

As indicated above, a panel-specific MPE report may be transmitted using a panel-specific MAC CE. In some cases, a MAC CE may include a power backoff indication field (referred to as a “P field”) that may be used to indicate a power backoff applied due to power management. In some cases, the P field may be used to indicate a measured value of a P-MPR. For example, the P field may be set to a specified value (e.g., 1) if P-MPR levels are being reported, in which case the P-MPR values may be reported. If the P-MPR levels are not to be reported, the P field may be set to a different specified value (e.g., 0) and reserve bits may be presented.

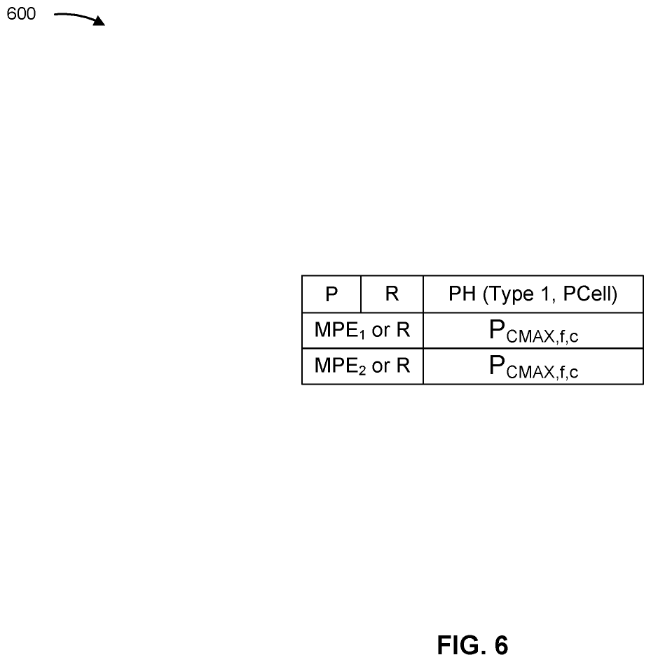

FIG. 6 is a diagram illustrating an example 600 of a portion of a MAC CE structure associated with reporting panel-specific MPE indications, in accordance with various aspects of the present disclosure. Example 600 may be generated and transmitted by a UE such as, for example, the UE 310 shown in FIG. 3.

As shown, the portion of the MAC CE structure includes a P field. In the case of panel-specific MPE reporting, the P field may be set to 1 if MPE is to be reported for at least one panel. In the illustrated example 600, the UE includes two panels and the MPE information associated with the first panel (shown as “MPE1”) may be reported in a first value field. MPE information associated with the second panel (shown as “MPE2”) may be reported in the second value field. If neither panel satisfies reporting conditions, reserve bits (shown as “R”) may be presented. For example, the UE may determine that at least one panel of a plurality of panels associated with a serving cell satisfies a reporting condition and may set a P field of the MAC CE equal to one based at least in part on determining that the at least one panel satisfies the reporting condition.

As indicated above, FIG. 6 is provided as an example. Other examples may differ from what is described with respect to FIG. 6.

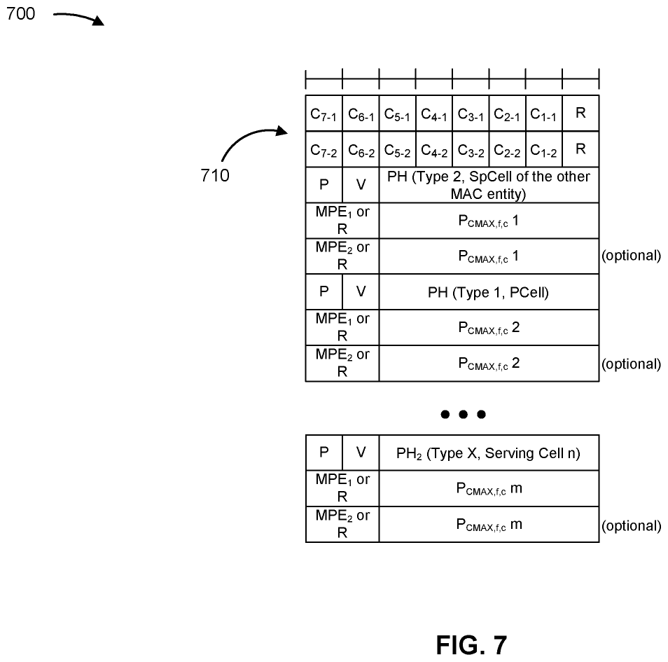

FIG. 7 is a diagram illustrating an example 700 of a portion of a MAC CE structure associated with reporting panel-specific MPE indications, in accordance with various aspects of the present disclosure. Example 700 may be generated and transmitted by a UE such as, for example, the UE 310 shown in FIG. 3.

As shown by the “optional” label, the UE may determining that at least one panel of a plurality of panels associated with a serving cell fails to satisfy the reporting condition, in which case the panel-specific MPE report may not include MPE information associated with the at least one additional panel based at least in part on determining that the at least one additional panel fails to satisfy the reporting condition. For example, the UE may only report MPE information for panels that satisfy reporting criteria.

In some aspects, as shown by reference number 710, the panel-specific MPE report may include a bitmap that indicates the at least one panel based at least in part on presenting an extended cell activation status field of the MAC CE. The extended C field may include two or more rows of cell activation status fields (known as “C fields”) that may indicate the panel that is being reported.

As indicated above, FIG. 7 is provided as an example. Other examples may differ from what is described with respect to FIG. 7.

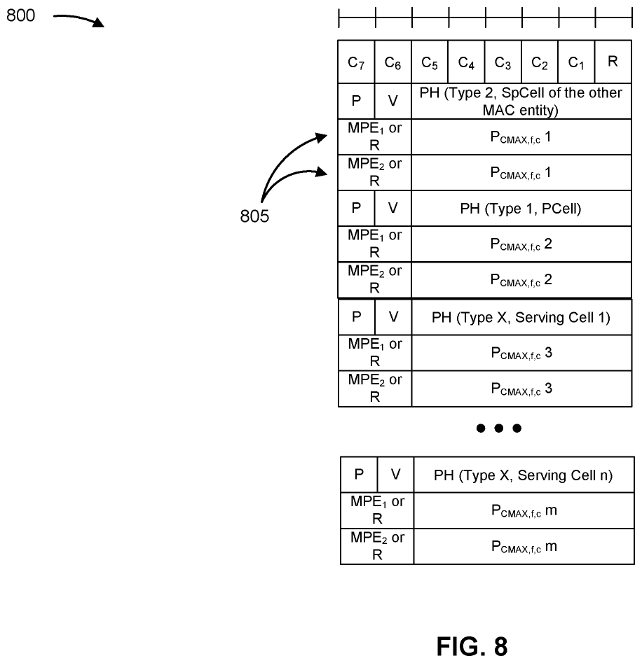

FIG. 8 is a diagram illustrating an example 800 of a MAC CE structure associated with reporting panel-specific MPE indications, in accordance with various aspects of the present disclosure. Example 800 may be generated and transmitted by a UE such as, for example, the UE 310 shown in FIG. 3.

As shown by reference number 805, the UE may always report MPE information for each panel using MPE fields (shown as MPE1, MPE2). If MPE information is not available to report, the UE may populate the fields with reserve bits (shown as “R”). As shown, the MAC CE may be categorized by power headroom type, cell type, and/or cell ID, among other examples. Since the UE always reports the MPE information for each panel, in some aspects, the network may be able to determine, from the reported information, one or more panels that do not have an MPE issue, since information will be included for those one or more panels. In this way, the network may implicitly identify a new candidate working panel.

As indicated above, FIG. 8 is provided as an example. Other examples may differ from what is described with respect to FIG. 8.

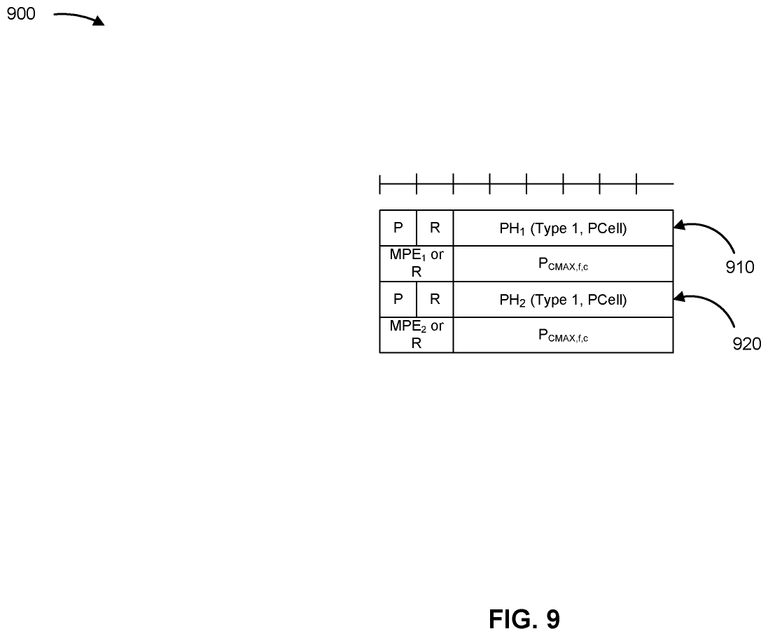

FIG. 9 is a diagram illustrating an example 900 of a MAC CE structure associated with reporting panel-specific MPE indications, in accordance with various aspects of the present disclosure. Example 900 may be generated and transmitted by a UE such as, for example, the UE 310 shown in FIG. 3. As shown, the UE may report MPE information using a P field indicator and an accompanying data field, as in FIG. 6. Example 900 includes a power headroom (PH) field that includes panel-specific PH information. For example, a first PH field 910 may include PH information associated with a first panel and a second PH field 920 may include PH information associated with a second panel.

As indicated above, FIG. 9 is provided as an example. Other examples may differ from what is described with respect to FIG. 9.

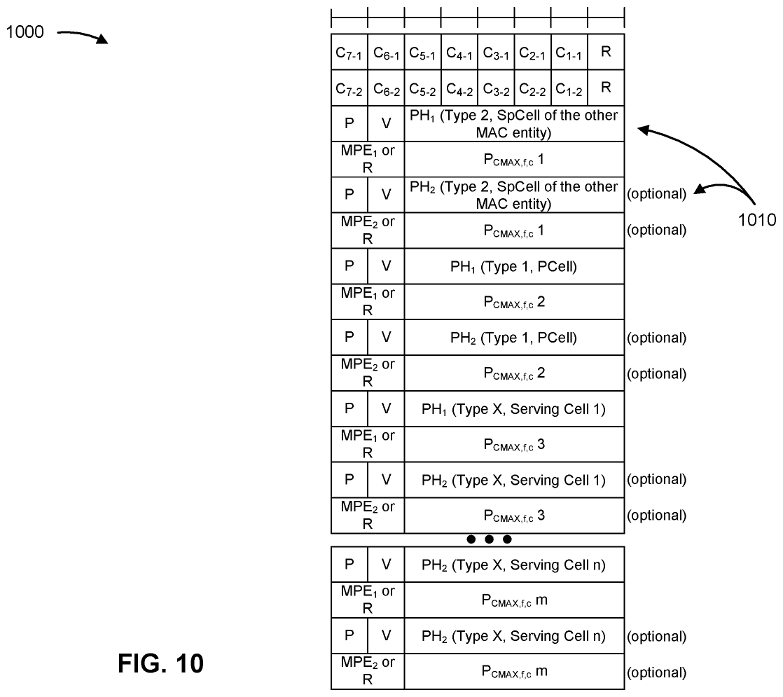

FIG. 10 is a diagram illustrating an example 1000 of a MAC CE structure associated with reporting panel-specific MPE indications, in accordance with various aspects of the present disclosure. Example 1000 may be generated and transmitted by a UE such as, for example, the UE 310 shown in FIG. 3. As shown, a UE may report MPE information only for those panels that satisfy a reporting condition, as in FIG. 7. As shown by reference number 1010, Example 1000 also includes separate panel-specific PH fields.

As indicated above, FIG. 10 is provided as an example. Other examples may differ from what is described with respect to FIG. 10.

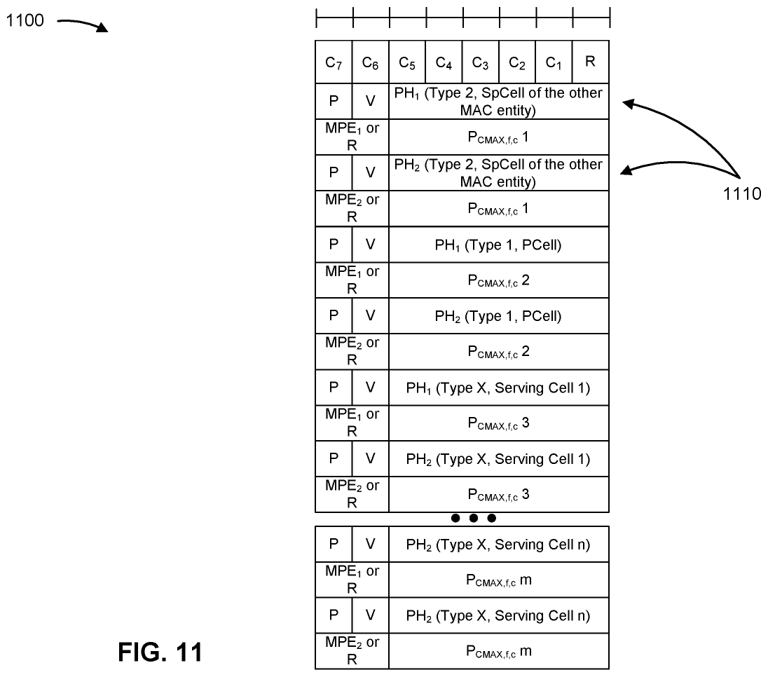

FIG. 11 is a diagram illustrating an example 1100 of a MAC CE structure associated with reporting panel-specific MPE indications, in accordance with various aspects of the present disclosure. Example 1100 may be generated and transmitted by a UE such as, for example, the UE 310 shown in FIG. 3. As shown, the UE may always report MPE information for all panels in each MAC CE, as in FIG. 8. As shown by reference number 1110, Example 1100 also includes separate panel-specific PH fields.

As indicated above, FIG. 11 is provided as an example. Other examples may differ from what is described with respect to FIG. 11.

FIG. 12 is a diagram illustrating an example process 1200 performed, for example, by a user equipment (UE), in accordance with various aspects of the present disclosure. Example process 1200 is an example where the UE (e.g., UE 120) performs operations associated with panel-specific MPE indications.

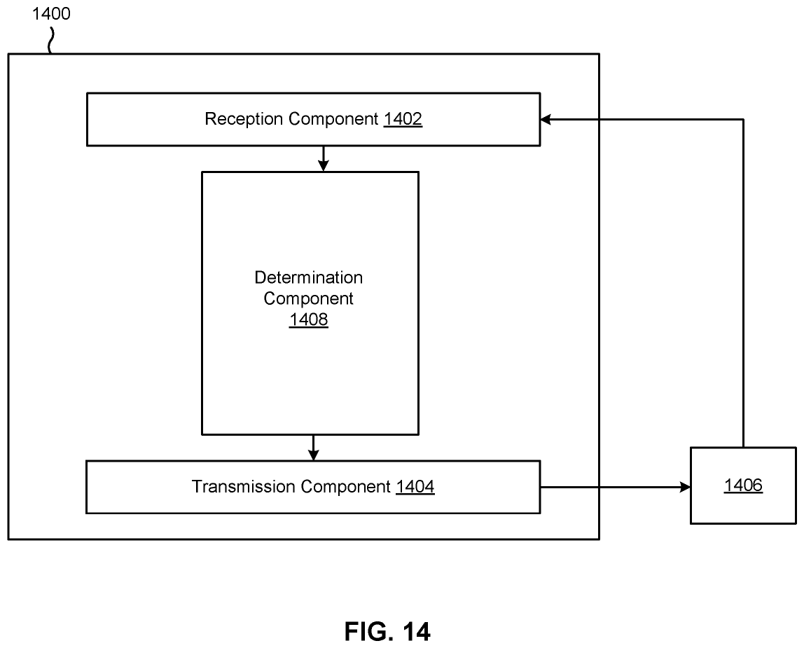

As shown in FIG. 12, in some aspects, process 1200 may include receiving a panel-specific MPE reporting configuration (block 1210). For example, the UE (e.g., using reception component 1402, depicted in FIG. 14) may receive a panel-specific MPE reporting configuration, as described above.

As further shown in FIG. 12, in some aspects, process 1200 may include transmitting a panel-specific MPE report based at least in part on the panel-specific MPE reporting configuration (block 1220). For example, the UE (e.g., using transmission component 1404, depicted in FIG. 14) may transmit a panel-specific MPE report based at least in part on the panel-specific MPE reporting configuration, as described above.

Process 1200 may include additional aspects, such as any single aspect or any combination of aspects described below and/or in connection with one or more other processes described elsewhere herein.

In a first aspect, the panel-specific MPE reporting configuration indicates one or more parameters to be reported.

In a second aspect, alone or in combination with the first aspect, the panel-specific MPE reporting configuration indicates a first set of parameters corresponding to a first panel, and a second set of parameters corresponding to a second panel.

In a third aspect, alone or in combination with one or more of the first and second aspects, process 1200 includes determining that at least one panel associated with a serving cell in a MAC entity, of a plurality of panels associated with a plurality of serving cells, has a corresponding P-MPR that satisfies a P-MPR threshold, wherein transmitting the panel-specific MPE report comprises transmitting the panel-specific MPE report based at least in part on determining that the at least one panel associated with the serving cell in the MAC entity has the corresponding P-MPR that satisfies the P-MPR threshold.

In a fourth aspect, alone or in combination with the third aspect, the panel-specific MPE report comprises panel-specific MPE information associated with the at least one panel.

In a fifth aspect, alone or in combination with one or more of the third through fourth aspects, the panel-specific MPE report comprises panel-specific MPE information associated with at least one additional panel of the plurality of panels.

In a sixth aspect, alone or in combination with one or more of the first through fifth aspects, process 1200 includes determining that a cumulative P-MPR satisfies a P-MPR threshold, wherein transmitting the panel-specific MPE report comprises transmitting the panel-specific MPE report based at least in part on determining that the cumulative P-MPR satisfies the P-MPR threshold.

In a seventh aspect, alone or in combination with the sixth aspect, the panel-specific MPE report comprises cumulative MPE information associated with a plurality of panels.

In an eighth aspect, alone or in combination with one or more of the first through seventh aspects, process 1200 includes determining that a cumulative P-MPR associated with a serving cell of a plurality of serving cells satisfies a P-MPR threshold, wherein transmitting the panel-specific MPE report comprises transmitting the panel-specific MPE report based at least in part on determining that the cumulative P-MPR associated with the serving cell satisfies the P-MPR threshold.

In a ninth aspect, alone or in combination with one or more of the first through eighth aspects, process 1200 includes determining that a relative P-MPR satisfies a power change threshold, wherein transmitting the panel-specific MPE report comprises transmitting the panel-specific MPE report based at least in part on determining that the relative P-MPR satisfies the power change threshold.

In a tenth aspect, alone or in combination with one or more of the first through ninth aspects, the power change threshold may be panel-specific.

In an eleventh aspect, alone or in combination with one or more of the first through tenth aspects, process 1200 includes determining that a relative P-MPR associated with at least one panel of a plurality of panels satisfies a power change threshold, wherein transmitting the panel-specific MPE report comprises transmitting the panel-specific MPE report based at least in part on determining that the relative P-MPR associated with the at least one panel satisfies the power change threshold.

In a twelfth aspect, alone or in combination with the eleventh aspect, process 1200 includes determining that a prohibition timer associated with the panel-specific MPE report is not running, wherein transmitting the panel-specific MPE report comprises transmitting the panel-specific MPE report based at least in part on determining that the prohibition timer associated with the panel-specific MPE is not running.

In a thirteenth aspect, alone or in combination with the twelfth aspect, process 1200 includes starting the prohibition timer associated with the relative P-MPR based at least in part on transmitting the panel-specific MPE report.

In a fourteenth aspect, alone or in combination with one or more of the twelfth through thirteenth aspects, the prohibition timer comprises a panel-specific prohibition timer.

In a fifteenth aspect, alone or in combination with one or more of the first through fourteenth aspects, the panel-specific MPE report comprises a MAC CE.

In a sixteenth aspect, alone or in combination with the fifteenth aspect, the MAC CE comprises a panel-specific MAC CE.

In a seventeenth aspect, alone or in combination with one or more of the fifteenth through sixteenth aspects, process 1200 includes determining that at least one panel of a plurality of panels associated with a serving cell satisfies a reporting condition, and setting a power backoff indication field of the MAC CE equal to one based at least in part on determining that the at least one panel satisfies the reporting condition.

In an eighteenth aspect, alone or in combination with the seventeenth aspect, process 1200 includes determining that at least one additional panel of the plurality of panels associated with the serving cell fails to satisfy the reporting condition, wherein the panel-specific MPE report does not include MPE information associated with the at least one additional panel based at least in part on determining that the at least one additional panel fails to satisfy the reporting condition.

In a nineteenth aspect, alone or in combination with one or more of the seventeenth through eighteenth aspects, the panel-specific MPE report comprises a bitmap that indicates the at least one panel.

In a twentieth aspect, alone or in combination with the nineteenth aspect, the bitmap comprises an extended cell activation status field of the MAC CE.

In a twenty-first aspect, alone or in combination with one or more of the seventeenth through twentieth aspects, the panel-specific MPE report comprises MPE information associated with each of the plurality of panels associated with the serving cell.

In a twenty-second aspect, alone or in combination with one or more of the fifteenth through twenty-first aspects, a power headroom field of the MAC CE comprises panel-specific power headroom information.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a base station, in accordance with various aspects of the present disclosure. Example process 1300 is an example where the base station (e.g., base station 110) performs operations associated with panel-specific MPE indications.

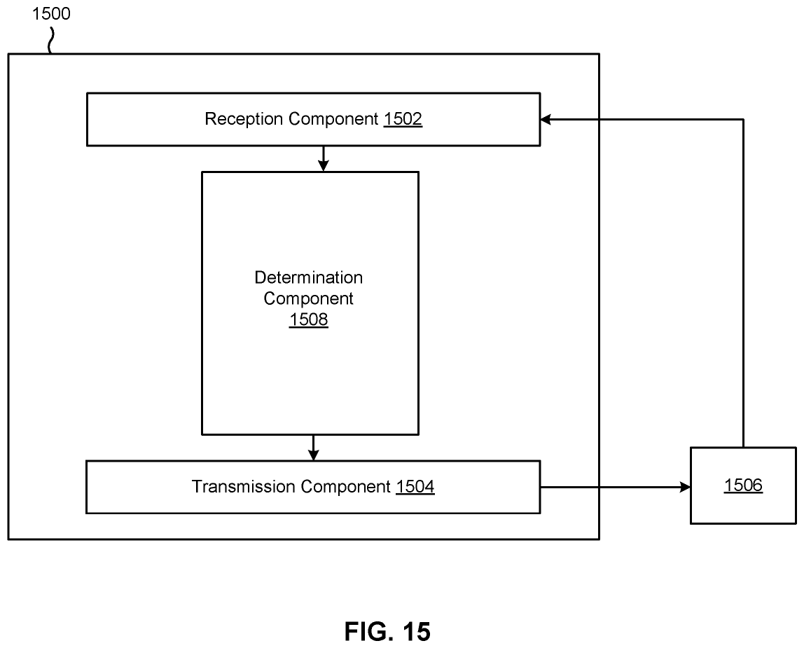

As shown in FIG. 13, in some aspects, process 1300 may include transmitting a panel-specific MPE reporting configuration (block 1310). For example, the base station (e.g., using transmission component 1504, depicted in FIG. 15) may transmit a panel-specific MPE reporting configuration, as described above.

As further shown in FIG. 13, in some aspects, process 1300 may include receiving a panel-specific MPE report based at least in part on the panel-specific MPE reporting configuration (block 1320). For example, the base station (e.g., using reception component 1502, depicted in FIG. 15) may receive a panel-specific MPE report based at least in part on the panel-specific MPE reporting configuration, as described above.

Process 1300 may include additional aspects, such as any single aspect or any combination of aspects described below and/or in connection with one or more other processes described elsewhere herein.

In a first aspect, the panel-specific MPE reporting configuration indicates one or more parameters to be reported.

In a second aspect, alone or in combination with the first aspect, the panel-specific MPE reporting configuration indicates a first set of parameters corresponding to a first panel, and a second set of parameters corresponding to a second panel.

In a third aspect, alone or in combination with one or more of the first and second aspects, receiving the panel-specific MPE report comprises receiving the panel-specific MPE report based at least in part on a determination that at least one panel associated with a serving cell in a MAC entity, of a plurality of panels associated with a plurality of serving cells, has a corresponding P-MPR that satisfies a P-MPR threshold.

In a fourth aspect, alone or in combination with the third aspect, the panel-specific MPE report comprises panel-specific MPE information associated with the at least one panel.

In a fifth aspect, alone or in combination with one or more of the third through fourth aspects, the panel-specific MPE report comprises panel-specific MPE information associated with at least one additional panel of the plurality of panels.

In a sixth aspect, alone or in combination with one or more of the first through fifth aspects, receiving the panel-specific MPE report comprises receiving the panel-specific MPE report based at least in part on a determination that a cumulative P-MPR satisfies a P-MPR threshold.

In a seventh aspect, alone or in combination with the sixth aspect, the panel-specific MPE report comprises cumulative MPE information associated with a plurality of panels.

In an eighth aspect, alone or in combination with one or more of the first through seventh aspects, receiving the panel-specific MPE report comprises receiving the panel-specific MPE report based at least in part on a determination that a cumulative P-MPR associated with a serving cell of a plurality of serving cells satisfies a P-MPR threshold.

In a ninth aspect, alone or in combination with one or more of the first through eighth aspects, receiving the panel-specific MPE report comprises receiving the panel-specific MPE report based at least in part on a determination that a relative power management maximum power reduction satisfies a power change threshold.

In a tenth aspect, alone or in combination with one or more of the first through ninth aspects, the power change threshold is panel-specific.

In an eleventh aspect, alone or in combination with one or more of the first through tenth aspects, receiving the panel-specific MPE report comprises receiving the panel-specific MPE report based at least in part on a determination that a relative P-MPR associated with at least one panel of a plurality of panels satisfies a power change threshold.

In a twelfth aspect, alone or in combination with the eleventh aspect, receiving the panel-specific MPE report comprises receiving the panel-specific MPE report based at least in part on a determination that a prohibition timer associated with the panel-specific MPE is not running.

In a thirteenth aspect, alone or in combination with the twelfth aspect, the prohibition timer comprises a panel-specific prohibition timer.

In a fourteenth aspect, alone or in combination with one or more of the first through thirteenth aspects, the panel-specific MPE report comprises a MAC CE.

In a fifteenth aspect, alone or in combination with the fourteenth aspect, the MAC CE comprises a panel-specific MAC CE.

In a sixteenth aspect, alone or in combination with one or more of the fourteenth through fifteenth aspects, a power backoff indication field of the MAC CE is set based at least in part on a determination that at least one panel of a plurality of panels associated with a serving cell satisfies a reporting condition.

In a seventeenth aspect, alone or in combination with the sixteenth aspect, the panel-specific MPE report does not include MPE information associated with at least one additional panel of the plurality of panels associated with the serving cell based at least in part on a determination that the at least one additional panel fails to satisfy the reporting condition.

In an eighteenth aspect, alone or in combination with one or more of the sixteenth through seventeenth aspects, the panel-specific MPE report comprises a bitmap that indicates the at least one panel.

In a nineteenth aspect, alone or in combination with the eighteenth aspect, the bitmap comprises an extended cell activation status field of the MAC CE.

In a twentieth aspect, alone or in combination with one or more of the sixteenth through nineteenth aspects, the panel-specific MPE report comprises MPE information associated with each of the plurality of panels associated with the serving cell.

In a twenty-first aspect, alone or in combination with one or more of the first through twentieth aspects, a power headroom field of the MAC CE comprises panel-specific power headroom information.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a block diagram of an example apparatus 1400 for wireless communication. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include a determination component 1408.

In some aspects, the apparatus 1400 may be configured to perform one or more operations described herein in connection with FIGS. 3-11. Additionally, or alternatively, the apparatus 1400 may be configured to perform one or more processes described herein, such as process 1200 of FIG. 12. In some aspects, the apparatus 1400 and/or one or more components shown in FIG. 14 may include one or more components of the UE described above in connection with FIG. 2. Additionally, or alternatively, one or more components shown in FIG. 14 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1406. In some aspects, the reception component 1402 may include one or more antennas, a demodulator, a MIMO detector, a receive processor, a controller/processor, a memory, or a combination thereof, of the UE described above in connection with FIG. 2.

The transmission component 1404 may transmit communications, such as reference signals, control information, data communications, or a combination thereof, to the apparatus 1406. In some aspects, one or more other components of the apparatus 1406 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modulator, a transmit MIMO processor, a transmit processor, a controller/processor, a memory, or a combination thereof, of the UE described above in connection with FIG. 2. In some aspects, the transmission component 1404 may be co-located with the reception component 1402 in a transceiver.

The reception component 1402 may receive a panel-specific MPE reporting configuration. The transmission component 1404 may transmit a panel-specific MPE report based at least in part on the panel-specific MPE reporting configuration.

The determination component 1408 may determine that at least one panel associated with a serving cell in a MAC entity, of a plurality of panels associated with a plurality of serving cells, has a corresponding P-MPR that satisfies a P-MPR threshold where transmitting the panel-specific MPE report comprises transmitting the panel-specific MPE report based at least in part on determining that the at least one panel associated with the serving cell in the MAC entity has the corresponding P-MPR that satisfies the P-MPR threshold. In some aspects, the determination component 1408 may include one or more antennas, a demodulator, a MIMO detector, a receive processor, a controller/processor, a memory, or a combination thereof, of the UE described above in connection with FIG. 2. In some aspects, the determination component 1408 may include the reception component 1402 and/or the transmission component 1404.

The determination component 1408 may determine that a cumulative P-MPR satisfies a P-MPR threshold, where transmitting the panel-specific MPE report comprises transmitting the panel-specific MPE report based at least in part on determining that the cumulative P-MPR satisfies the P-MPR threshold.

The determination component 1408 may determine that a cumulative P-MPR associated with a serving cell of a plurality of serving cells satisfies a P-MPR threshold, where transmitting the panel-specific MPE report comprises transmitting the panel-specific MPE report based at least in part on determining that the cumulative P-MPR associated with the serving cell satisfies the P-MPR threshold.

The determination component 1408 may determine that a relative P-MPR satisfies a power change threshold, where transmitting the panel-specific MPE report comprises transmitting the panel-specific MPE report based at least in part on determining that the relative P-MPR satisfies the power change threshold.

The determination component 1408 may determine that a relative P-MPR associated with at least one panel of a plurality of panels satisfies a power change threshold wherein transmitting the panel-specific MPE report comprises transmitting the panel-specific MPE report based at least in part on determining that the relative P-MPR associated with the at least one panel satisfies the power change threshold.

The determination component 1408 may determine that a prohibition timer associated with the panel-specific MPE report is not running, where transmitting the panel-specific MPE report comprises transmitting the panel-specific MPE report based at least in part on determining that the prohibition timer associated with the panel-specific MPE report is not running.

The determination component 1408 may start the prohibition timer associated with the relative P-MPR based at least in part on transmitting the panel-specific MPE report. The determination component 1408 may determine that at least one panel of a plurality of panels associated with a serving cell satisfies a reporting condition. The determination component 1408 may set a power backoff indication field of the MAC CE equal to one based at least in part on determining that the at least one panel satisfies the reporting condition.

The determination component 1408 may determine that at least one additional panel of the plurality of panels associated with the serving cell fails to satisfy the reporting condition wherein the panel-specific MPE report does not include MPE information associated with the at least one additional panel based at least in part on determining that the at least one additional panel fails to satisfy the reporting condition.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a block diagram of an example apparatus 1500 for wireless communication. The apparatus 1500 may be a base station, or a base station may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include a determination component 1508.

In some aspects, the apparatus 1500 may be configured to perform one or more operations described herein in connection with FIGS. 3-11. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the base station described above in connection with FIG. 2. Additionally, or alternatively, one or more components shown in FIG. 15 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1506. In some aspects, the reception component 1502 may include one or more antennas, a demodulator, a MIMO detector, a receive processor, a controller/processor, a memory, or a combination thereof, of the base station described above in connection with FIG. 2.

The transmission component 1504 may transmit communications, such as reference signals, control information, data communications, or a combination thereof, to the apparatus 1506. In some aspects, one or more other components of the apparatus 1506 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modulator, a transmit MIMO processor, a transmit processor, a controller/processor, a memory, or a combination thereof, of the base station described above in connection with FIG. 2. In some aspects, the transmission component 1504 may be co-located with the reception component 1502 in a transceiver.

The transmission component 1504 may transmit a panel-specific MPE reporting configuration. The reception component 1502 may receive a panel-specific MPE report based at least in part on the panel-specific MPE reporting configuration. The determination component 1508 may determine one or more configurations, and/or resource allocations, among other examples. In some aspects, the determination component 1508 may include one or more antennas, a modulator, a transmit MIMO processor, a transmit processor, a controller/processor, a memory, or a combination thereof, of the base station described above in connection with FIG. 2. In some aspects, the determination component 1508 may include the reception component 1502 and/or the transmission component 1504.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some aspects of the present disclosure:

Aspect 1: A method of wireless communication performed by a user equipment (UE), comprising: receiving a panel-specific maximum permitted exposure (MPE) reporting configuration; and transmitting a panel-specific MPE report based at least in part on the panel-specific MPE reporting configuration.

Aspect 2: The method of aspect 1, wherein the panel-specific MPE reporting configuration indicates one or more parameters to be reported.

Aspect 3: The method of either of aspects 1 or 2, wherein the panel-specific MPE reporting configuration indicates: a first set of parameters corresponding to a first panel; and a second set of parameters corresponding to a second panel.

Aspect 4: The method of any of aspects 1-3, further comprising determining that at least one panel associated with a serving cell in a medium access control (MAC) entity, of a plurality of panels associated with a plurality of serving cells, has a corresponding power management maximum power reduction (P-MPR) that satisfies a P-MPR threshold, wherein transmitting the panel-specific MPE report comprises transmitting the panel-specific MPE report based at least in part on determining that the at least one panel associated with the serving cell in the MAC entity has the corresponding P-MPR that satisfies the P-MPR threshold.

Aspect 5: The method of aspect 4, wherein the panel-specific MPE report comprises panel-specific MPE information associated with the at least one panel.

Aspect 6: The method of either of aspects 4 or 5, wherein the panel-specific MPE report comprises panel-specific MPE information associated with at least one additional panel of the plurality of panels.

Aspect 7: The method of any of aspects 1-6, further comprising determining that a cumulative power management maximum power reduction (P-MPR) satisfies a P-MPR threshold, wherein transmitting the panel-specific MPE report comprises transmitting the panel-specific MPE report based at least in part on determining that the cumulative P-MPR satisfies the P-MPR threshold.

Aspect 8: The method of aspect 7, wherein the panel-specific MPE report comprises cumulative MPE information associated with a plurality of panels.

Aspect 9: The method of any of aspects 1-8, further comprising determining that a cumulative power management maximum power reduction (P-MPR) associated with a serving cell of a plurality of serving cells satisfies a P-MPR threshold, wherein transmitting the panel-specific MPE report comprises transmitting the panel-specific MPE report based at least in part on determining that the cumulative P-MPR associated with the serving cell satisfies the P-MPR threshold.

Aspect 10: The method of any of aspects 1-9, further comprising determining that a relative power management maximum power reduction (P-MPR) satisfies a power change threshold, wherein transmitting the panel-specific MPE report comprises transmitting the panel-specific MPE report based at least in part on determining that the relative P-MPR satisfies the power change threshold.

Aspect 11: The method of any of aspects 1-10, further comprising determining that a relative power management maximum power reduction (P-MPR) associated with at least one panel of a plurality of panels satisfies a power change threshold, wherein transmitting the panel-specific MPE report comprises transmitting the panel-specific MPE report based at least in part on determining that the relative P-MPR associated with the at least one panel satisfies the power change threshold.

Aspect 12: The method of any of aspects 1-11, wherein the power change threshold is panel-specific.

Aspect 13: The method of any of aspects 1-12, further comprising determining that a prohibition timer associated with the panel-specific MPE report is not running, wherein transmitting the panel-specific MPE report comprises transmitting the panel-specific MPE report based at least in part on determining that the prohibition timer associated with the panel-specific MPE report is not running.

Aspect 14: The method of aspect 13, further comprising starting the prohibition timer associated with the panel-specific MPE report based at least in part on transmitting the panel-specific MPE report.

Aspect 15: The method of either of aspects 13 or 14, wherein the prohibition timer comprises a panel-specific prohibition timer.

Aspect 16: The method of any of aspects 1-15, wherein the panel-specific MPE report comprises a medium access control (MAC) control element (CE).

Aspect 17: The method of aspect 16, wherein the MAC CE comprises a panel-specific MAC CE.

Aspect 18: The method of either of aspects 16 or 17, further comprising: determining that at least one panel of a plurality of panels associated with a serving cell satisfies a reporting condition; and setting a power backoff indication field of the MAC CE based at least in part on determining that the at least one panel satisfies the reporting condition.

Aspect 19: The method of aspect 18, further comprising determining that at least one additional panel of the plurality of panels associated with the serving cell fails to satisfy the reporting condition, wherein the panel-specific MPE report does not include MPE information associated with the at least one additional panel based at least in part on determining that the at least one additional panel fails to satisfy the reporting condition.

Aspect 20: The method of either of aspects 18 or 19, wherein the panel-specific MPE report comprises a bitmap that indicates the at least one panel.

Aspect 21: The method of aspect 20, wherein the bitmap comprises an extended cell activation status field of the MAC CE.

Aspect 22: The method of any of aspects 18-21, wherein the panel-specific MPE report comprises MPE information associated with each of the plurality of panels associated with the serving cell.

Aspect 23: The method of any of aspects 16-22, wherein a power headroom field of the MAC CE comprises panel-specific power headroom information.

Aspect 24: A method of wireless communication performed by a base station, comprising: transmitting a panel-specific maximum permitted exposure (MPE) reporting configuration; and receiving a panel-specific MPE report based at least in part on the panel-specific MPE reporting configuration.

Aspect 25: The method of aspect 24, wherein the panel-specific MPE reporting configuration indicates one or more parameters to be reported.

Aspect 26: The method of either of aspects 24 or 25, wherein the panel-specific MPE reporting configuration indicates: a first set of parameters corresponding to a first panel; and a second set of parameters corresponding to a second panel.

Aspect 27: The method of any of aspects 24-26, wherein receiving the panel-specific MPE report comprises receiving the panel-specific MPE report based at least in part on a determination that at least one panel associated with a serving cell in a medium access control (MAC) entity, of a plurality of panels associated with a plurality of serving cells, has a corresponding power management maximum power reduction (P-MPR) that satisfies a P-MPR threshold.

Aspect 28: The method of aspect 27, wherein the panel-specific MPE report comprises panel-specific MPE information associated with the at least one panel.

Aspect 29: The method of either of aspects 27 or 28, wherein the panel-specific MPE report comprises panel-specific MPE information associated with at least one additional panel of the plurality of panels.

Aspect 30: The method of any of aspects 24-29, wherein receiving the panel-specific MPE report comprises receiving the panel-specific MPE report based at least in part on a determination that a cumulative power management maximum power reduction (P-MPR) satisfies a P-MPR threshold.

Aspect 31: The method of aspect 30, wherein the panel-specific MPE report comprises cumulative MPE information associated with a plurality of panels.

Aspect 32: The method of any of aspects 24-31, wherein receiving the panel-specific MPE report comprises receiving the panel-specific MPE report based at least in part on a determination that a cumulative power management maximum power reduction (P-MPR) associated with a serving cell of a plurality of serving cells satisfies a P-MPR threshold.

Aspect 33: The method of any of aspects 24-32, wherein receiving the panel-specific MPE report comprises receiving the panel-specific MPE report based at least in part on a determination that a relative power management maximum power reduction satisfies a power change threshold.

Aspect 34: The method of any of aspects 24-33, wherein the power change threshold is panel-specific.

Aspect 35: The method of any of aspects 24-34, wherein receiving the panel-specific MPE report comprises receiving the panel-specific MPE report based at least in part on a determination that a relative power management maximum power reduction (P-MPR) associated with at least one panel of a plurality of panels satisfies a power change threshold.

Aspect 36: The method of any of aspects 23-33, wherein receiving the panel-specific MPE report comprises receiving the panel-specific MPE report based at least in part on a determination that a prohibition timer associated with the panel-specific MPE report is not running.

Aspect 37: The method of aspect 36, wherein the prohibition timer comprises a panel-specific prohibition timer.

Aspect 38: The method of any of aspects 24-37, wherein the panel-specific MPE report comprises a medium access control (MAC) control element (CE).

Aspect 39: The method of aspect 38, wherein the MAC CE comprises a panel-specific MAC CE.

Aspect 40: The method of either of aspects 38 or 39, wherein a power backoff indication field of the MAC CE is set based at least in part on a determination that at least one panel of a plurality of panels associated with a serving cell satisfies a reporting condition.

Aspect 41: The method of aspect 40, wherein the panel-specific MPE report does not include MPE information associated with at least one additional panel of the plurality of panels associated with the serving cell based at least in part on a determination that the at least one additional panel fails to satisfy the reporting condition.

Aspect 42: The method of either of aspects 40 or 41, wherein the panel-specific MPE report comprises a bitmap that indicates the at least one panel.

Aspect 43: The method of aspect 42, wherein the bitmap comprises an extended cell activation status field of the MAC CE.

Aspect 44: The method of any of aspects 40-43, wherein the panel-specific MPE report comprises MPE information associated with each of the plurality of panels associated with the serving cell.

Aspect 45: The method of any of aspects 38-44, wherein a power headroom field of the MAC CE comprises panel-specific power headroom information.

Aspect 46: An apparatus for wireless communication at a device, comprising a processor; memory coupled with the processor; and instructions stored in the memory and executable by the processor to cause the apparatus to perform the method of one or more aspects of aspects 1-23.

Aspect 47: A device for wireless communication, comprising a memory and one or more processors coupled to the memory, the memory and the one or more processors configured to perform the method of one or more aspects of aspects 1-23.

Aspect 48: An apparatus for wireless communication, comprising at least one means for performing the method of one or more aspects of aspects 1-23.

Aspect 49: A non-transitory computer-readable medium storing code for wireless communication, the code comprising instructions executable by a processor to perform the method of one or more aspects of aspects 1-23.

Aspect 50: A non-transitory computer-readable medium storing a set of instructions for wireless communication, the set of instructions comprising one or more instructions that, when executed by one or more processors of a device, cause the device to perform the method of one or more aspects of aspects 1-23.

Aspect 51: An apparatus for wireless communication at a device, comprising a processor; memory coupled with the processor; and instructions stored in the memory and executable by the processor to cause the apparatus to perform the method of one or more aspects of aspects 24-45.

Aspect 52: A device for wireless communication, comprising a memory and one or more processors coupled to the memory, the memory and the one or more processors configured to perform the method of one or more aspects of aspects 24-45.

Aspect 53: An apparatus for wireless communication, comprising at least one means for performing the method of one or more aspects of aspects 24-45.

Aspect 54: A non-transitory computer-readable medium storing code for wireless communication, the code comprising instructions executable by a processor to perform the method of one or more aspects of aspects 24-45.

Aspect 55: A non-transitory computer-readable medium storing a set of instructions for wireless communication, the set of instructions comprising one or more instructions that, when executed by one or more processors of a device, cause the device to perform the method of one or more aspects of aspects 24-45.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1-30. (canceled)

31. A user equipment (UE) for wireless communication, comprising:
one or more memories; and
one or more processors operatively coupled to the one or more memories, the memory and the one or more processors configured to:
receive a panel-specific maximum permitted exposure (MPE) reporting configuration; and
transmit a panel-specific MPE report based at least in part on the panel-specific MPE reporting configuration.

32. The UE of claim 31, wherein the panel-specific MPE reporting configuration indicates one or more parameters to be reported.

33. The UE of claim 31, wherein the panel-specific MPE reporting configuration indicates:
a first set of parameters corresponding to a first panel; and
a second set of parameters corresponding to a second panel.

34. The UE of claim 31, wherein the one or more memories and the one or more processors are further configured to determine that at least one panel associated with a serving cell in a medium access control (MAC) entity, of a plurality of panels associated with a plurality of serving cells, has a corresponding power management maximum power reduction (P-MPR) that satisfies a P-MPR threshold,
wherein the one or more memories and the one or more processors, when transmitting the panel-specific MPE report, are configured to transmit the panel-specific MPE report based at least in part on determining that the at least one panel associated with the serving cell in the MAC entity has the corresponding P-MPR that satisfies the P-MPR threshold.

35. The UE of claim 34, wherein the panel-specific MPE report comprises panel-specific MPE information associated with the at least one panel.

36. The UE of claim 34, wherein the panel-specific MPE report comprises panel-specific MPE information associated with at least one additional panel of the plurality of panels.

37. The UE of claim 31, wherein the one or more memories and the one or more processors are further configured to determine that a cumulative power management maximum power reduction (P-MPR) satisfies a P-MPR threshold,
wherein the one or more memories and the one or more processors, when transmitting the panel-specific MPE report, are configured to transmit the panel-specific MPE report based at least in part on determining that the cumulative P-MPR satisfies the P-MPR threshold.

38. The UE of claim 37, wherein the panel-specific MPE report comprises cumulative MPE information associated with a plurality of panels.

39. The UE of claim 31, wherein the one or more memories and the one or more processors are further configured to determine that a cumulative power management maximum power reduction (P-MPR) associated with a serving cell of a plurality of serving cells satisfies a P-MPR threshold,
wherein the one or more memories and the one or more processors, when transmitting the panel-specific MPE report, are configured to transmit the panel-specific MPE report based at least in part on determining that the cumulative P-MPR associated with the serving cell satisfies the P-MPR threshold.

40. The UE of claim 31, wherein the one or more memories and the one or more processors are further configured to determine that a relative power management maximum power reduction (P-MPR) satisfies a power change threshold,
wherein the one or more memories and the one or more processors, when transmitting the panel-specific MPE report, are configured to transmit the panel-specific MPE report based at least in part on determining that the relative P-MPR satisfies the power change threshold.

41. The UE of claim 31, wherein the one or more memories and the one or more processors are further configured to determine that a relative power management maximum power reduction (P-MPR) associated with at least one panel of a plurality of panels satisfies a power change threshold,
wherein the one or more memories and the one or more processors, when transmitting the panel-specific MPE report, are configured to transmit the panel-specific MPE report based at least in part on determining that the relative P-MPR associated with the at least one panel satisfies the power change threshold.

42. The method of claim 41, wherein the power change threshold is panel-specific.

43. The UE of claim 31, wherein the one or more memories and the one or more processors are further configured to determine that a prohibition timer associated with the panel-specific MPE report is not running,
wherein the one or more memories and the one or more processors, when transmitting the panel-specific MPE report, are configured to transmit the panel-specific MPE report based at least in part on determining that the prohibition timer associated with the panel-specific MPE report is not running.

44. The UE of claim 43, wherein the one or more memories and the one or more processors are further configured to start the prohibition timer associated with the panel-specific MPE report based at least in part on transmitting the panel-specific MPE report.

45. The UE of claim 43, wherein the prohibition timer comprises a panel-specific prohibition timer.

46. The UE of claim 31, wherein the panel-specific MPE report comprises a medium access control (MAC) control element (CE).

47. The UE of claim 46, wherein the MAC CE comprises a panel-specific MAC CE.

48. The UE of claim 46, wherein the one or more memories and the one or more processors are further configured to:
determine that at least one panel of a plurality of panels associated with a serving cell satisfies a reporting condition; and
set a power backoff indication field of the MAC CE based at least in part on determining that the at least one panel satisfies the reporting condition.

49. The UE of claim 48, wherein the one or more memories and the one or more processors are further configured to determine that at least one additional panel of the plurality of panels associated with the serving cell fails to satisfy the reporting condition,
wherein the panel-specific MPE report does not include MPE information associated with the at least one additional panel based at least in part on determining that the at least one additional panel fails to satisfy the reporting condition.

50. The UE of claim 48, wherein the panel-specific MPE report comprises a bitmap that indicates the at least one panel.

51. The UE of claim 50, wherein the bitmap comprises an extended cell activation status field of the MAC CE.

52. The UE of claim 48, wherein the panel-specific MPE report comprises MPE information associated with each of the plurality of panels associated with the serving cell.

53. The UE of claim 46, wherein a power headroom field of the MAC CE comprises panel-specific power headroom information.

54. A base station for wireless communication, comprising:
one or more memories; and
one or more processors operatively coupled to the one or more memories, the memory and the one or more processors configured to:
transmit a panel-specific maximum permitted exposure (MPE) reporting configuration; and
receive a panel-specific MPE report based at least in part on the panel-specific MPE reporting configuration.

55. A method of wireless communication performed by a user equipment (UE), comprising:
receiving a panel-specific maximum permitted exposure (MPE) reporting configuration; and
transmitting a panel-specific MPE report based at least in part on the panel-specific MPE reporting configuration.

56. The method of claim 55, further comprising determining that at least one panel associated with a serving cell in a medium access control (MAC) entity, of a plurality of panels associated with a plurality of serving cells, has a corresponding power management maximum power reduction (P-MPR) that satisfies a P-MPR threshold,
wherein transmitting the panel-specific MPE report comprises transmitting the panel-specific MPE report based at least in part on determining that the at least one panel associated with the serving cell in the MAC entity has the corresponding P-MPR that satisfies the P-MPR threshold.

57. The method of claim 55, further comprising determining that a cumulative power management maximum power reduction (P-MPR) satisfies a P-MPR threshold,
wherein transmitting the panel-specific MPE report comprises transmitting the panel-specific MPE report based at least in part on determining that the cumulative P-MPR satisfies the P-MPR threshold.

58. The method of claim 55, further comprising determining that a cumulative power management maximum power reduction (P-MPR) associated with a serving cell of a plurality of serving cells satisfies a P-MPR threshold,
wherein transmitting the panel-specific MPE report comprises transmitting the panel-specific MPE report based at least in part on determining that the cumulative P-MPR associated with the serving cell satisfies the P-MPR threshold.

59. The method of claim 55, further comprising determining that a relative power management maximum power reduction (P-MPR) satisfies a power change threshold,
wherein transmitting the panel-specific MPE report comprises transmitting the panel-specific MPE report based at least in part on determining that the relative P-MPR satisfies the power change threshold.

60. A method of wireless communication performed by a base station, comprising:
transmitting a panel-specific maximum permitted exposure (MPE) reporting configuration; and
receiving a panel-specific MPE report based at least in part on the panel-specific MPE reporting configuration.
